(19) United States
(12) Patent Application Publication
(10) Pub. No.: US 2008/0111659 A1
(43) Pub. Date: May 15, 2008

(54) Access Control System With Multi-Segment Access Codes and Automatic Void List Deletion

(76) Inventor: Dominic Pesapane, Cheshire, CT (US)

Correspondence Address: MICHAEL BEST & FRIEDRICH LLP, 100 EAST WISCONSIN AVE, SUITE 3300, MILWAUKEE, WI, 53202-4108, US

(21) Appl. No.: 10/592,274

(22) PCT Filed: Mar. 9, 2005
(86) PCT No.: PCT/US05/07657

§ 371 Date: Sep. 6, 2007

Related U.S. Application Data
(60) Provisional application No. 60/551,593, filed on Mar. 9, 2004.

(51) Int. Cl. G05B 19/00

(52) U.S. Cl. 340/5.6

(57) ABSTRACT

An access control system is for at least first and second doors each having a lock adjustable between locked and unlocked states. A key has a code including first and second segments. A first controller coupled with the first door lock has a stored value and is configured to receive the key code and to compare at least the code first segment with the stored value, and unlocks the first lock when the code first segment corresponds with the stored value. A second controller coupled with the second door lock has a stored value and is configured to receive the key code and to compare at least the second code segment with the second stored value, and unlocks the second lock when either the code second segment corresponds with the second stored value or both code segments correspond with separate portions of the second value.

### BACKGROUND OF THE INVENTION

The present invention relates to lock systems, and more particularly to controllers and keys for such lock systems.

Certain door locks include a latch or bolt engageable with a frame to prevent relative displacement between the latch and frame. Typically, a do or having such a lock includes interior and exterior handles that are each rotated, pushed or otherwise displaced so as to disengage the latch from the frame to enable the door to be opened. Often, such door locks are provided with a device for preventing disengagement of the latch, for example by preventing movement of one or both handles. Some of these locks include electronic systems for preventing latch disengagement, such as by providing a clutch or other device that enables one or both handles to be disengaged from operative connection with the latch/bolt. Other types of locks include an electromagnet mounted on a door or frame that magnetically engages with a steel plate or another magnet on the other one of the frame or door, so as to secure the door within the frame by magnet force.

Often, each of the above types of locks include a controller that operates the clutching device, relay, or other device for locking/unlocking the dour, and a key device (e.g., fob, swipe card, iButton, etc.) for initiating authorized operation of the controller. Generally, such controllers include a stored list of authorized user values or a predefined access value, and the key device includes a code with one authorized user value or the lock access value. However, with either the code system, the ability to provide numerous individual users with different access privileges within a single system containing many doors, and thus locks and associated controllers, has often been found generally unsatisfactory.

### SUMMARY OF THE INVENTION

In one aspect, the present invention is an access control system for at least one structure having at least first and second doors, each door having a lock adjustable between a locked state and an unlocked state. The control system comprises a key with a code, the code including at least a first segment and a second segment. A first controller is operatively coupled with the first door lock and has a memory with a stored value. The controller is configured to receive the code from the key, to compare at least the first value segment with the stored value, and to adjust the first door lock to the unlocked state when the controller determines that the code first segment corresponds with the first controller value. Further, a second controller is operatively coupled with the second door lock and has a memory with a stored value. The second controller is configured to receive the code from the key, to compare at least the code second segment with the second controller stored value, and to adjust the second door lock to the unlocked state when the second controller determines one of that the code second segment corresponds with the second controller value and that the code first segment corresponds with a first portion of the second controller value and the code second segment corresponds with a second portion of the second controller value.

In another aspect, the present invention is an access control system for at least one structure having at least one door, the door having a lock adjustable between a locked state and an unlocked state. The control system comprises at least one key having a code, the code including at least one access segment, an identifier segment, and an expiration date segment. A controller is operatively coupled with the door lock and has a memory with a stored access value and a void file, the void file being configured to store at least one void value with an identifier portion and an expiration date portion. The controller is configured to receive the code from the key, to compare the key access segment with the stored access value and the identifier segment with the identifier portion of each void file value. The controller is further configured to separately remove each one of the void values from the void file at least one of on or after the expiration date of the void value and when the void file includes a predetermined maximum number of void values and the one void value has an expiration date earlier than the expiration date of each one of the other void values.

In a further aspect, the present invention is an access control system for use with at least two doors, each door having a lock adjustable between a locked state and an unlocked state. The control system comprises a key having a first code and a second code and a first controller operatively coupled with the lock of a first one of the two doors and having a memory with a stored value. The controller is configured to receive the first and second codes from the key, to select one of first and second codes, to compare the selected code with the stored value, and to adjust the first door lock to the unlocked state when the controller determines that the selected code corresponds with the first controller stored value. Further, a second controller is operatively coupled with the lock of a second one of the two doors and has a memory with a stored value. The second controller is configured to receive the first and second codes from the key, to select one of first and second codes, to compare the selected code with the second controller stored value, and to adjust the second door lock to the unlocked state when the second controller determines that the selected code corresponds with the second controller stored value.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is a top plan view of the access control system in accordance with the present invention, shown applied to an office building;

FIG. 2 is an elevational view of the access control system, shown applied to two buildings;

FIGS. 3A and 3B, collectively FIG. 3, are each more diagrammatic views of a key being presented to first and second lock controllers of the access control system;

FIG. 4 is logic flow diagram depicting the basic operations of each lock controller when presented with a key having a single code;

FIG. 5 is logic flow diagram depicting operation of each lock controller when presented with a key having multiple codes;

FIG. 6 is a plan view of a preferred embodiment of a key with a single code;

FIG. 7 is a plan view of a preferred embodiment of a key with a multiple codes;

FIG. 8 is a partly broken-away, elevational view of an exemplary lock assembly;

FIG. 9 is a schematic view of a lock controller and certain lock assembly components; and

FIG. 10 is a more diagrammatic view of a lock controller and associated lock components.

### DETAILED DESCRIPTION OF THE INVENTION

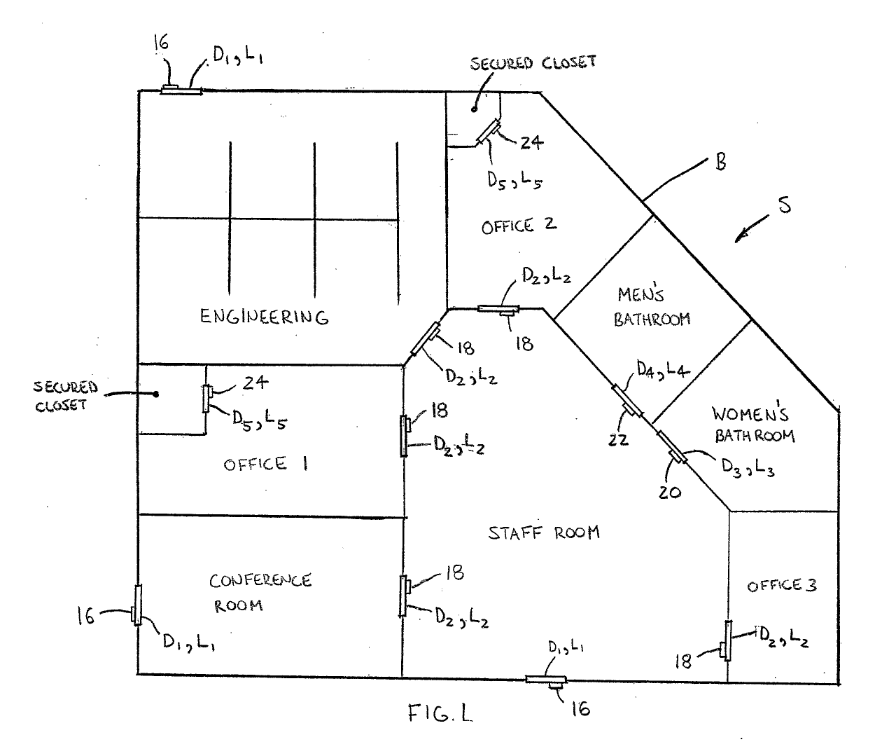

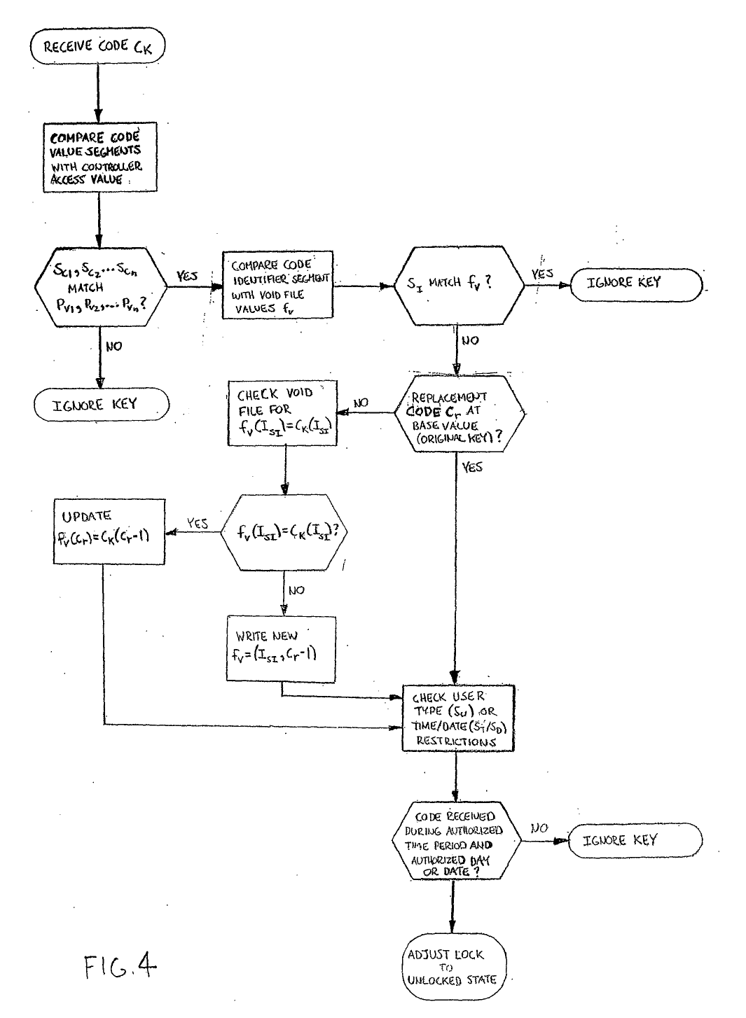

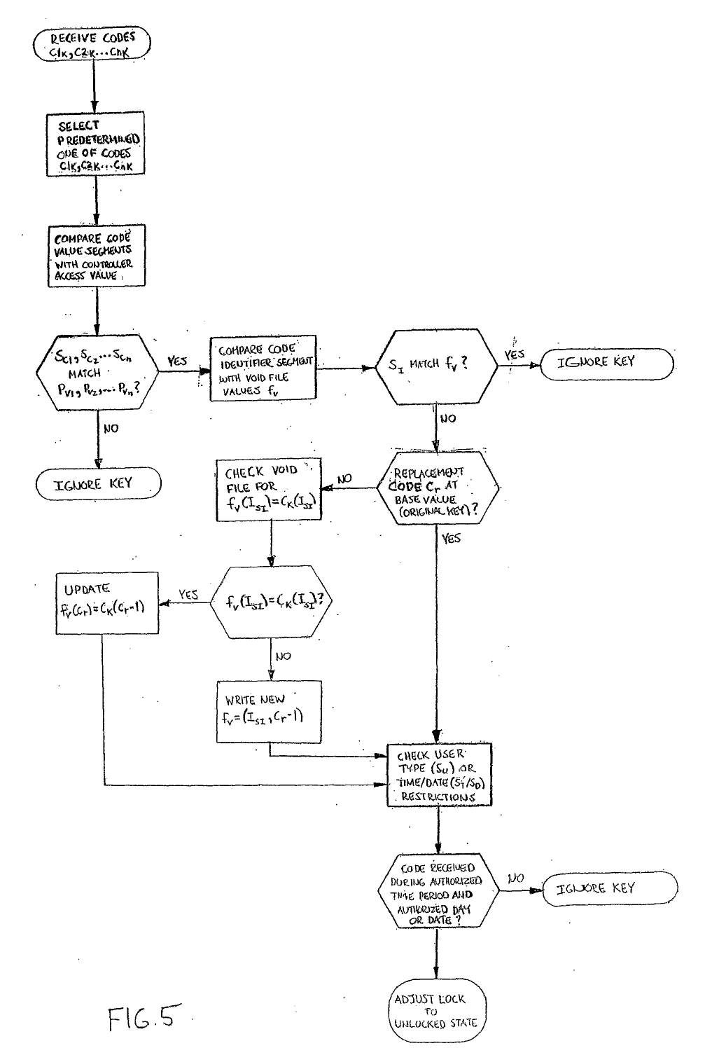

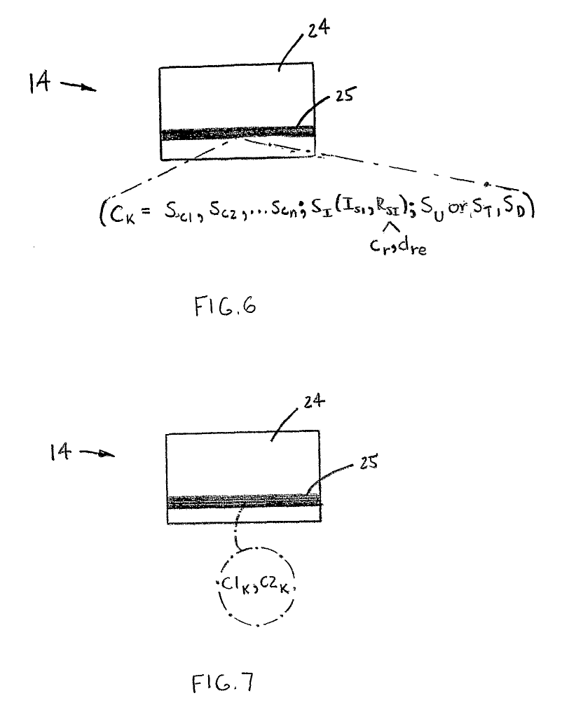

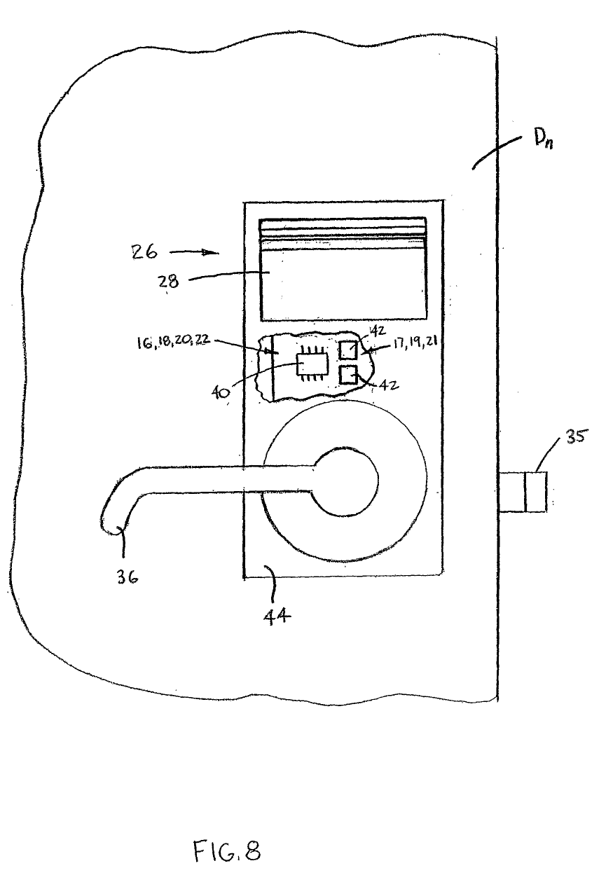

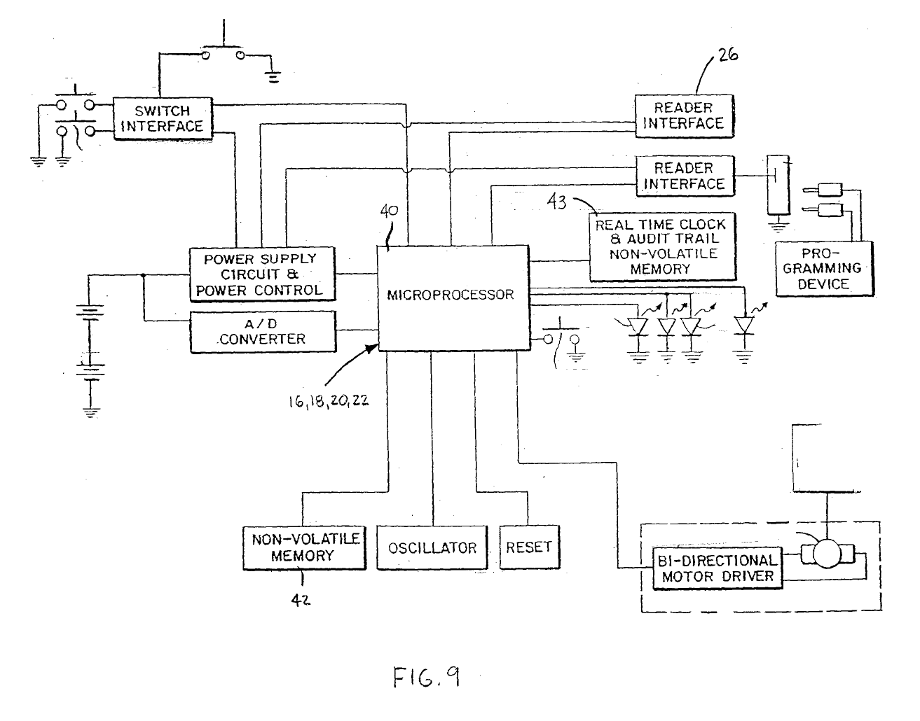

Referring now to the drawings in detail, wherein like numbers are used to indicate like elements throughout, there is shown in FIGS. 1-10 an access control system 10 for at least one structure S having at least first and second doors D₁, D₂, respectively, each door D₁, D₂ having a lock L₁, L₂, respectively. The control system 10 may be used with any desired structure(s) S, which include any type or number of buildings (e.g., two buildings B₁, B₂), but may also include vehicles, tunnel complexes, or any other structure that may have two or more doors D₁, D₂, etc. Each lock L₁, L₂ is adjustable between a locked state (e.g. exterior handle disconnected from retractor, bolt or latch extended, magnet(s) powered, etc.) so as to secure the associated door D₁, D₂ within a separate frame F and an unlocked state (e.g., exterior handle connected with retractor, retracted bolt/latch, unpowered magnet, etc.), so as to permit displacement of the door D₁, D₂ with respect to the particular frame F, as discussed in greater detail below. Although primarily discussed herein with reference to first and second doors D₁, D₂, the access control system 10 may be used with any desired number of first doors DI and/or second doors D₁, and/or with one or more third door(s) D₃, fourth doors D₄, etc., the designation of “first”, “second”, “third”, etc., being used to indicate one or more doors Dₙ having generally identical “characteristics” and intended user “access values” as defined below.

The access control system 10 basically comprises at least one and preferably a plurality of keys 14, at least one first controller 16 operatively coupled with one first door D₁ and at least one second controller 18 operatively coupled with one second door D₂. Each key 14 has a code C_{K} including at least a first segment S_{C1} and a second segment S_{C2}, and may include any desired number of code segments S_{Cn}, (e.g., a third segment S_{C3}, etc.) as described in greater detail below. Preferably, at least one key 14 is a first key 15A and the control system 10 further comprises at least one and preferably a plurality of other keys 14, such as a second key 1 5B, a third key 15C, etc., which each provide different access privileges to the one or more doors D₁, D₂, D₃, etc., through which access is monitored or regulated by control system 10 of the present invention, as described below.

Further, each first lock controller 16 has a memory 17 with a stored access value V_{A1}, which preferably corresponds with one or more characters representing one or more attributes or characteristics of the specific door D₁ to which the particular lock L₁ is coupled. The first lock controller 16 is configured (i.e., programmed, provided with appropriate software, hard-wired, etc.) to receive the code C_{K} from each key 14 and to compare at least the code first segment S_{C1} with the stored access value V_{A1}, and may compare two or more code segments S_{C1}, Sc₂, etc., with the access value V_{A1}. The lock controller(s) 16 are each configured to adjust the coupled first door lock L₁ to the unlocked state when the controller 16 determines that the code first segment S_{C1} “corresponds with” the first controller access value V_{A1}, or alternatively that both the code first and second segments S_{C1}, S_{C1} each correspond with a separate portion P_{V11}, P_{V12} of the access value V_{A1}, as discussed below. Furthermore, each second controller 18 has a memory 19 with a stored access value V_{A2}, which includes one or more characters representing certain attributes of the particular second door D₂. The second lock controller(s) 18 are configured to receive the code C_{K} from each key 14 and to compare at least the code second segment S_{C2} with the stored access value VA₂, and may compare two or more code segments S_{C1}, S_{C2}, etc., with the access value V_{A2}. Preferably, each controller memory 17, 19 is programmable such that the access values V_{A1}, V_{A2} are variable or adjustable, as discussed below.

Further, the second lock controller(s) 18 are each configured to adjust the coupled second door lock L₂ to the unlocked state when the controller 18 determines that the code second segment S_{C2} corresponds with the second access value V_{A2}, or alternatively that both the code first and second segments S_{C1}, S_{C2} each correspond with separate portion P_{V21}, P_{V22}, respectively, of the access value VA₂, as described in greater detail below. However, if the first controller 16 is configured to require both key code segments S_{C1}, S_{C2} to correspond with each portion of the first stored access value V_{A1}, either the second controller 18 should require only the code second segment S_{C2} to correspond with the stored access value V_{A2}, or the criteria for determining “correspondence” (discussed in detail below) should be different than the correspondence criteria of the first controller 16, for the following reasons. Further, although the controllers are designated as first controller(s) 16 and second controller(s) 18, the first and second controllers 16, 18 (and other controllers, as discussed below) are preferably generally identically constructed (i.e., same type of microprocessor, etc.) and differ primarily by having different access values V_{A1}, V_{A2} and/or different methodology for determining correspondence between the code(s) C_{K} and particular value V_{A1} or V_{A2}, as described in detail below.

By constructing the access control system 10 such that each lock controller 16, 18 has different access values V_{A1}, V_{A2}, or has different criteria for determining correspondence, the access system 10 may be designed to provide different users with different privileges to access the various doors D₁, D₂, etc., of the system 10. More specifically, as mentioned above, the access control system 10 is preferably used with a plurality of the keys 15A, 15B, etc., each assigned to a different user and having at least one code C_{K} with code segments S_{C1}, S_{C2}, etc., that are different than the segments S_{C1}, S_{C2}, of each other key 15A, 15B, etc. As such, one key (e.g. 15A) may provide the assigned user with access through both the first and second doors D₁, D₂, while another key (e.g., 15B) may permit the assigned user to access only one of the two doors D₁ or D₂.

For example, an access control system 10 may be constructed with first and second keys 15A, 15B each having a code C_{K} with two segments S_{C1}, S_{C2}, each segment S_{C1}, S_{C2} including two characters, and with the first and second controller access values V_{A1}, V_{A2} each including four characters, as follows:
First Key 15B C_{K1}=1111; S_{C11}=11, S_{C12}=11
Second Key 15A C_{K2}=1100; S_{C21}=11, S_{C22}=00
First Controller Value V_{A1}=1100; P_{V11}=11, P_{V12}=00
Second Controller Value V_{A2}=1111; P_{V21}=11, P_{V22}=11

With this exemplary system 10, when either the first and second keys 15A, 15B are used to access the first door D₁, the first controller 16 may compare each key first segment S_{C11}, S_{C21} with the access value first portion P_{V11}, determine that each key code C_{K1}, C_{K2} corresponds with the first access value V_{A1}, and adjust the coupled first lock LI to the unlocked state. Further, when the first key 15A is used to access the second door D₂, the second lock controller 18 may compare each of the key first and second segments S_{C11}, S_{C12} with the second access value V_{A2}, determine that the first segment S_{C11} corresponds with a first value portion P_{V21} and the second segment S_{C12} corresponds with a second value portion P_{V22}, and then adjusts the coupled door lock L₂ to the unlocked state. However, when the second key 15B is used to access the second door D₂, the second lock controller 18 may compare each of the key first and second segments S_{C21}, S_{C22} with the second access value V_{A2}, determine that the code first segment S_{C21} corresponds with the first value portion P_{V21}, but that the code second segment S_{C22} does not correspond with the second value portion PV₂₂ (i.e., 00≠1). As such, the second controller 18 will not adjust the coupled door lock L₂ to the unlocked state (i.e., the door D₂ remains “locked”) when the second key 15A is used to access the second door D₂. Alternatively, the second lock controller 18 may be configured to compare only the code second segment S_{C12}, S_{C22} of each key 15A, 15B with the access value second portion P_{V22}, or compare each code C_{K1}, C_{K2} as an entire string to the entire second access value V_{A2}, and achieve the same result.

Thus, the exemplary control system 10 is arranged to provide two users with privilege to access a first door D₁ (e.g., a building exterior door), but only the first user has the privilege to access the second door D₂ (e.g., a building interior door). The previous example is used to illustrate certain basic features of the access control system 10 of the present invention, and additional, more detailed examples are presented below.

Furthermore, as mentioned above, each of the key codes C_{K} may have three or more code segments S_{C1}, S_{C2}, S_{C3}, S_{C4}, etc., and either or both controllers 16, 18 may be configured to further compare the third segment S_{C3}, the fourth segment S_{C4}, etc., with the particular stored access value V_{A1} or V_{A2}. For example, the control system 10 may have a key(s) 14 having a code C_{K} with three segments S_{C1}, S_{C2}, S_{C3} and with one or both controllers 16 or 18 configured to compare the third segment C_{S3} with the controller stored value V_{A1} or V_{A2}. The controller(s) 16 may further be configured to adjust the associated lock L₁, L₂ to the unlocked state when the code third segment S_{C3} corresponds with a portion of the access value V_{A1}, V_{A2} (or the entire value V_{A1}, V_{A2}), when the third segment S_{C3} corresponds with a portion (e.g., P_{V3}) of the access value V_{A1}, V_{A2} and at least one of first and second segments S_{C1}, S_{C2} corresponds with another portion (e.g., P_{V1}, P_{V2}) of the stored value V_{A1}, VA₂, or that all three code segments S_{C1}, S_{C2}, S_{C3} correspond with a separate one of three access value portions P_{V1}, P_{V2}, P_{V3}, respectively. Such a code comparison scheme may be extended to any number of code segments S_{C1}, S_{C2}, S_{C3}, . . . S_{Cn}, and/or access value portions P_{V1}, P_{V2}, P_{V3}, . . . P_{V1}.

Additionally, the access control system 10 may include one or more third controllers 20, fourth controllers 22, etc., each coupled with the lock L₃, L₄, etc., of a respective third door D₃, fourth door D₄, etc., each having a different access value V_{A3}, V_{A4} and requiring different criteria for enabling access through the associated door D₃, D₄. For example, the access control system 10 may have one or more keys 14 having a code C_{K} with three segments S_{C1}, S_{C2} and S_{C3} and any number of first, second, and third controllers 16, 18, 20, respectively, controlling access through associated doors D₁, D₂, D₃. With such a system 10, the first and second controllers 16, 18 may be configured as described above, and the third controller(s) 20 may be configured to compare at least the third segment S_{C3} with the third access value V_{A3} stored in a memory 21, and to adjust the coupled door lock L₃ to the unlocked state when the controller 20 determines one of the following: that the third segment S_{C3} corresponds with the third access value V_{A3}, that the first and third segments S_{C1}, Sc₃ or second and third segments S_{C2}, SC₃, correspond with separate one of two access value portions P_{V1}, P_{V2}, or that all three code segments S_{C1}, SC₂, S_{C3} correspond with a separate one of three access value portions P_{V1}, P_{V2}, P_{V3}. Thus, the capability of using three or more different controllers 16, 18, 20, etc., further expands the capability of the access control system 10 to provide different access privileges to different users, as discussed above and in greater detail below.

Besides the capability of having specific key codes C_{K} with any desired number of code segments S_{Cn}, the access control system 10 may also include one or more keys 14 each having two or more different codes C_{Kn}, such as for example, a first code C1_{K} and a second code C2_{K}. With such a control system 10, the first and second controllers 16, 18 may each be configured to receive both the first and second codes C1_{K}, C2_{K} and to select the first code C2_{K} for comparison with the particular access value V_{A1} or V_{A2}, as discussed above. A third controller 20 (and possibly also a fourth controller 22, etc.) may be configured to receive both the first and second codes C1_{K}, C2_{K} from the same key 14, to select and compare the second code C2_{K} with a third access value V_{A3}, and to adjust a third door lock L₃ to an unlocked state when the third controller 20 determines that at least a portion of the second code C2_{K} corresponds with at least a portion of the third access value V_{A3}. The access control system 10 can have keys 14 with any desired number of codes Cn_{K} and any desired number of different controllers 16, 18, 20, 22, etc., each selectively utilizing different codes Cn_{K} to determine authorized access through the associated door D₁, D₂, D₃, etc. Thus, by providing multiple codes C1_{K}, C2_{K}, C3_{K}, etc., on a single key 14, the flexibility of the access control system 10 is even further increased.

Preferably, each lock controller 16, 18, 20, etc., is configured to determine that one of the code segment S_{C1}, S_{C2}, S_{C3}, etc., corresponds with the controller access value V_{An} (or a portion thereof) under at least one of the following (or other) conditions:
1) The code segment S_{Cn} has a value equal to the access value V_{An} (S_{Cn}=V_{An});
2) The code segment S_{Cn} has a value greater than the access value V_{An} (S_{Cn}<V_{An});
3) The code segment S_{Cn} has a value lesser than the access value V_{An} (S_{Cn}>V_{An});
4) The code segment S_{Cn} has a value equal to a portion of the controller value V_{An} (S_{Cn}=P_{Vn});
5) The code segment S_{Cn} has a value greater than a portion of the controller value V_{An} (S_{Cn}>P_{Vn});
6) The code segment S_{Cn} has a value lesser than a portion of the controller value V_{An} (S_{Cn}<Pᵥₙ); or
7) A portion of the one code segment S_{Cn} has a value equal to a portion of the controller value V_{An} (portion S_{Cn}=P_{Vn}, i.e., a “wildcard match”).

In other words, each lock controller 16, 18, 20, 22, etc., of the access control system 10 may be configured to determine correspondence of a key code C_{K}, or code segment S_{Cn}, with an access value V_{An} (or portion thereof) under any desired “matching rule”. Such correspondence or matching may include an exact match (e.g., S_{Cn}=P_{Vn}), greater than or equal to match, a wildcard match, a match defined by a mathematical formula or other logical relationship, or even no match at all. Further, each controller 16, 18, 20, etc. may each be programmed or constructed to determine correspondence under a matching rule(s) different than the other controllers 16, 18, 20, etc. and/or to determine correspondence between different code segments S_{C1}, S_{C2}, etc., under different matching rules (e.g., S_{C1}=V_{An1}, S_{C2}>V_{An2}).

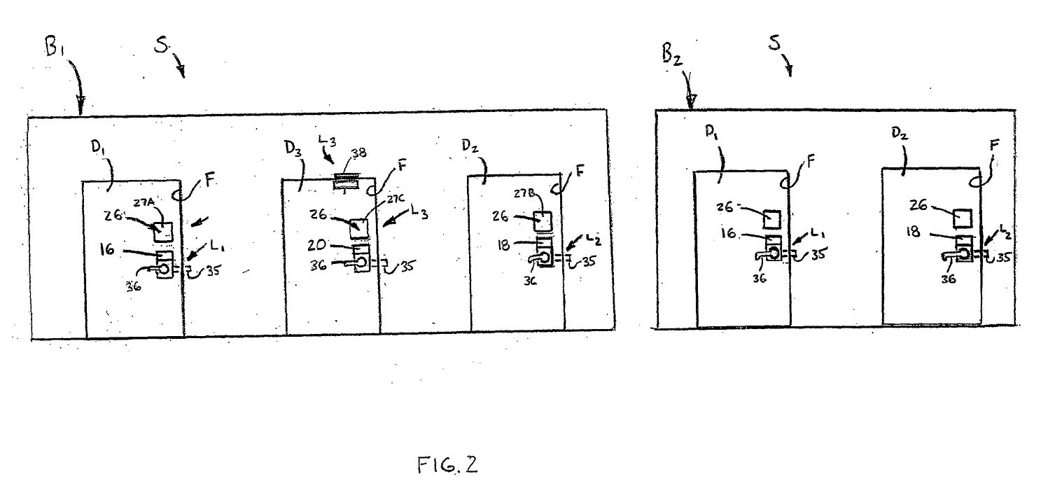

Referring to FIGS. 2, 3 and 8-10 the access control system 10 preferably farther comprises a plurality of input devices 26 each coupled with a separate one of the lock controllers 16, 18, 20, etc. Specifically, a first input device 27A, a second input device 27B, a third input device 27C, etc. are each configured to receive the code C_{K} from each key 14 and to transmit the code C_{K} respectively to the first controller 16, the second controller 18, the third controller 20, etc. As best shown in FIG. 8, each input device 26 is preferably a card reader 28 configured to “read” an electromagnetic stripe on the preferred key 14, as discussed below. However, the input devices 26 may each be alternatively provided by an iButton port, a wireless receiver, a bar code scanner, an optical scanner, or any other device capable of reading or receiving a code from an appropriate key device or credential. In any case, when a user desires to access a particular door D₁, D₂, D₃, etc., the user “presents” the key 14, such that the key 14 engages or interacts with the input device 26 to cause the key code C_{K} to be transmitted to the particular lock controller 16, 18, 20, 22, etc.

Referring now to FIGS. 6 and 7, each key 14 preferably includes a carrier or body 30 and a storage medium 32 disposed on the body 30 and configured to store or contain the key code C_{K}. The storage medium 32 may include a magnetic stripe (as depicted), a memory chip, a bar code, a holograph, a switching circuit or any component or device capable of storing data. Preferably, the key code C_{K} is encoded data stored in the medium 32 and accessible by each lock controller 16, 18, 20, 22, etc., by means of an appropriate input device 26, as discussed above. However, each key 14 may alternatively include switching circuit (not shown) configured to generate a signal, as opposed to merely storing the encoded data, that contains the code C_{K} and a wireless transmitter (not depicted) for sending the coded signal as an electromagnetic wave.

Furthermore, each key code segment S_{C1}, S_{C2} is equated to or corresponds with at least one character, such that the key code C_{K} includes a plurality or “string” of characters. For example, the key code C_{K} may correspond with a string of five characters, with a code first segment S_{C1}, including two of the characters and a code second segment S_{C2} including the remaining three characters of the string. Most preferably, each code character is one of sixteen characters of the hexadecimal numbering system, i.e., numbers 0-9 and letters A-F. However, the code characters may be of any other known number, letter, symbol, etc., or systems thereof, as desired by the person(s) establishing the access criteria of the control system 10.

Preferably, the access value V_{An} of each lock controller 16, 18, 20, 22, etc. indicates at least one property or characteristic P_{Dn} of the associated door Dₙ and most preferably each access value V_{An} has a plurality of value portions P_{Vn1}, P_{Vn2}, etc. each indicating a separate characteristic of the associated door Dₙ. In other words, the access value V_{A1} of the first controller 16 indicates at least one property or characteristic P_{D1} of the first door D₁, the stored value V_{A2} of the second controller 18 indicates at least one characteristic P_{D2} of the associated second door D₂, etc. Such door characteristics PD, may include, but are not limited to, specific door location (e.g., 15 West, Room 322, etc.), security level (e.g., low, high, restricted, etc.), department (math, science, engineering, sales, etc.), authorized user gender (i.e., male, female, both genders), door type (e.g., interior, exterior, closet, cabinet, etc.), intended user position/rank/office (staff member, manager, captain, senator, etc.), and may include any other characteristic deemed relevant to the person(s) establishing or implementing the access control system 10. Further, to enable different access privileges to be established, at least one of the doors (e.g., the second door D₂) has a characteristic P_{D2} that the other door (e.g., the first door D₁) lacks, for example, the second door D₂ may be for female users only or a high security door, whereas the first door D₁ is intended for use by all authorized users of the control system 10.

By establishing the controller access values V_{An} to correspond with one or more characteristics P_{Dn} of the associated door Dₙ, the desired access privileges for a particular user may be implemented by writing, generating, etc., that user's key code C_{K} to include code segments S_{Cn} which correspond to the characteristics P_{Dn}, of those doors Dₙ to which user access is intended to be granted. In other words, the code C_{Kn} of each key 14 is preferably generated, written, etc. such that each code segment S_{C1}, S_{C2}, S_{C3}, etc., corresponds with a separate characteristic of each door D₁, D₂, D₃, etc., to which the authorized key user is intended to have access privileges. As such, the code C_{K} of each key 14 preferably has two or more segments S_{C1}, S_{C2}, etc., enabling access to two or more doors D₁, D₂, etc., but may have only a single segment, character, etc., permitting access to one or more doors D₁ of a single type (e.g., only exterior doors).

For example, a structure S may have one or more first doors D₁ which are exterior doors for use by both genders and one or more second doors D₂ that are interior doors D₂ for use by women only (e.g., a women's bathroom). As such, the access value V_{A1} for each such first door D₁ may include one or more characters indicating an exterior door (e.g., 00) and one of more characters indicating both genders (e. g., 00). The access value for each second door D₂ may include one or more characters indicating an interior door (e.g., 01) and one of more characters indicating only the female gender (e.g., 01).

With this system 10, a female user intended to access privileges to both doors D₁, D₂ may be assigned a first key 15A with a code C_{K1} (e.g., 0101) having two codes segments S_{C11}=01, S_{C12}=01. A male user may be assigned a second key 15B with a code C_{K} (e.g., 0100) having two codes segments S_{C11}=01, S_{C12}=00. As such, when the female user presents the first key 15A to each of the first and second door controllers 16, 18, each controller 16, 18 determines that the first key code C_{K1} corresponds with each access value V_{A1}, V_{A2} and provides the female user with access through both doors D₁, D₂. The male user will be able to use the second key 15B to access the exterior door D₁, but when the male user presents the second key 15B to the second door controller 18, the second controller 18 should be configured to determine that the second key code C_{K2} does not correspond with the second access value V_{An}, and deny access through the second door D₂.

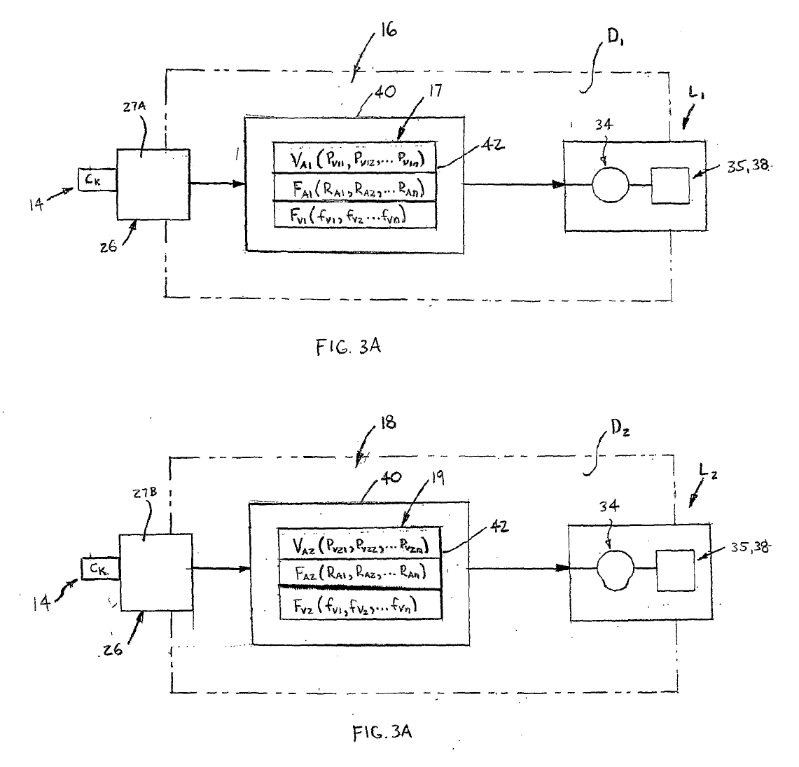

Referring to FIGS. 3 and 6, the two or more code segments S_{C1}, S_{C2}, etc. corresponding to the authorized door characteristics P_{Dn} are access segments (i.e., defining the access privileges) and each key code C_{K} preferably further includes a user identifier segment S₁ indicating the identity of the assigned key user and may also include an expiration date segment S_{E}, for reasons discussed below. The key code identifier segment S₁ preferably includes a user identity portion I_{SI} and a replacement code portion R_{SI}. The user identity portion I_{SI} preferably includes one or more characters which uniquely identify a specific user. Further, the replacement code portion R_{SI} includes at least a value/character cᵣ indicating whether or not the particular key 14 has been reissued to the user, and if so, the expiration date dᵣₑ (i.e., from an expiration date segment S_{E}, as discussed below) of the key 14 that has been replaced (e.g., a lost or stolen key 14). For example, the first time a key 14 has been issued to a specific user, the replacement code R_{SI} for that particular key 14 may be set at an “initial issue” or base code value cᵣ (e.g., 01) without any expiration date dᵣₑ. When this key 14 is replaced, the replacement code portion R_{SI} of the new key 14 is preferably written to include both an incrementally increased replacement code value cᵣₑ (i.e., 02) and an replacement expiration date dᵣₑ corresponding the expiration date of the replaced key 14, if any, (e.g. “106” indicating an expiration date of January 2006), such that the replacement code R_{SI} of the new key 14 would be R_{SI}=02106. As such, when a key 14 is lost or stolen, the authorized user may be issued a new key 14 having the same access privileges (i.e., access code segments S_{C1}, S_{C2}, etc.), but with an identifier segment S_{I} having a replacement code portion R_{SI} updated or modified as described, which enables the control system 10 to distinguish the new key 14 from the lost/stolen key 14, and prevent the use thereof as described below.

Further, each controller 16, 18, 20, etc. of the system 10 preferably further includes an audit file F_{A} and a void user file F_{V} stored in the controller memory 17, 19, 21, etc. The controllers 16, 18, 20, etc. are each preferably configured to create an audit record R_{A} within the audit file F_{A} whenever a key 14 is used, each audit record R_{A} preferably including at least the code identifier segment S_{I} of the particular key 14 and data corresponding to the time and date of key usage. Also, the controllers 16, 18, 20, etc. are also configured to compare the code identifier segment S_{I} with each value fv (if any) in the void file F_{V} and to prevent lock operation when the identifier segment S_{I} corresponds with a value in the void file F_{V}. More specifically, each void file value fv preferably includes data corresponding to a voided key's identifier segment S_{I}, most preferably both the identity portion I_{SI} and the replacement code portion R_{SI}. When a key 14 having an identifier segment S_{I} listed within a controller's void file F_{V} is presented to a door controller 16, 18, 20, etc., the particular controller will not operate the coupled lock L₁, L₂, L₃, etc. even if the access segments S_{C1}, S_{C2}, etc. correspond with door access value V_{A1}, V_{A2}, V_{A3}, etc. Thus, the provision of the controller void files F_{V} enable the access control system 10 to prevent the use of a key 14 that has been lost, stolen and/or replaced.

Furthermore, each controller 16, 18, 20, etc., is preferably further configured to create new void file entries or values fv in the following manner. When a key 14 is presented to a lock controller 16, 18, 20, etc., the particular controller will determine that the key 14 has been replaced when it reads the replacement code portion R_{SI} of the key code identifier segment S_{I} and the replacement code value cᵣ is greater than the original issue/base value cᵣ and has an expiration date dᵣₑ, as discussed above. In such cases, when the controller 16, 18, 20, etc. searches the void file F_{V} for any value f_{V} with the same code identifier segment S_{I} (S_{I} (I_{SI}, R_{SI})=f_{V} (I_{SI}, R_{SI})) as discussed above, the particular controller 16, 18, 20, etc. also preferably searches for any void values f_{V} that have the same identity portion I_{SI} and an earlier replacement code R_{SI}. If such a void value f_{V} is found, the controller 16, 18, 20, etc. “updates” the void value f_{V} to have a replacement code value cᵣ equal to the value of the key's replacement code cᵣ reduced by one (or by whatever inclement the replaced codes cᵣ are increased), i.e., fv (Cᵣ)=C_{K} ( Cᵣ)−1, and with the same expiration date dᵣₑ as the key code replacement expiration date dᵣₑ(i.e., f_{V} (dᵣₑ)=C_{K} (dᵣₑ)) . However, if no such void value f_{V} is found, the controller 16, 18, 20, etc. writes a new void value fv having the code identifier segment I_{SI} and a replacement code portion R_{SI} with an incrementally-reduced replacement code value cᵣ (i.e., f_{V} (cᵣ)=C_{K} (Cᵣ)−1) and the key code expiration date dᵣₑ(i.e., f_{V} (dᵣₑ)=C_{K} (dᵣₑ)). Alternatively or in addition to automatically created void file value f_{V}, the controllers 16, 18, 20, etc. may each be configured to receive void file values fv from an appropriate programming device or data transfer device (none depicted) Further, each key code C_{K} may further have a “user type” code segment C_{U} providing different time and/or weekday restrictions or privileges for each one of a plurality of different authorized users of a particular access system 10. For example, a first user type designated by a character “A” may permit access to authorized doors twenty four hours a day, seven days a week, a second user type designated by character “B” may permit access twenty four hours a day, but only on weekdays, a third user type designated by character “C” may permit access only between 6:00 a.m. and 8:00 p.m. and only on weekdays, etc. Further, the lock controllers 16, 18, 20, etc. each preferably has a clock and calendar 43 (see FIG. 9) and are programmed to apply the user type restrictions rules, such that for example, a user presenting a key 14 with a user type code segment S_{U}=C on a Saturday will be denied access by each lock controller even if the code access segments S_{C1}, S_{C2}, etc. match the lock controller access value V_{An}. The access control system 10 may have any desired number of different user types, each applying any desired time, day or other variable restriction, and/or the user type restrictions may be recognized by all lock controllers 16, 18, 20, etc. of the system 10 or only by certain controllers and ignored by the remainder.

As an alternative to using a user type segment code C_{U}, each key code C_{K} may instead have an authorized usage time segment S_{T} and an authorized day or date segment S_{D}. The code time segment S_{T} indicates either an authorized usage period (e.g., between 7:00 am and 6:00 p.m.) or an unauthorized usage period (e.g., between 6:00 p.m. and 7:00 am), and the code date segment SD indicates either an authorized usage day or date (e.g., weekdays, between Jan. 1, 2005 and Jun. 1, 2005) or an unauthorized usage day/date (e.g., Saturdays and Sundays, after Jun. 1, 2005). Further, each controller 16, 18, 20, etc., is configured to prevent operation of the associated lock L₁, L₂, L₃ when the controller 16, 18, 20, etc., determines from the code time segment S_{T} that the key code C_{K} is being received during an unauthorized usage period or determines from the code date segment S_{D} that the key code C_{K} is being received during an unauthorized usage period. However, as some users may be intended to have access privileges at all times or/and on all days or dates, certain key codes C_{K} may not have either or both of the code time segment S_{T} and the code date segment S_{D}.

Furthermore, each key code C_{K} may further include an activation date segment S_{A} indicating a date on (or after) which the particular key 14 is authorized and each controller 16, 18, 20, etc. may be configured to ignore any key 14 that is presented before the date indicated by the code activation date segment SA. Preferably, each key code C_{K} also further includes an expiration date segment S_{E} and each lock controller 16, 18, 20, etc. is further configured to “ignore” the code C_{K}, such that the associated lock L₁, L₂, L₃, etc. remains in the locked state, when a key 14 is presented after the date of the code expiration segment S_{E}. As such, a user may be provided with access privileges within the control system 10 for only a limited time period or be required to have their access privileges periodically renewed. Further, as keys 14 may be lost prior to the expiration date, the control system 10 preferably has the capability of denying access to such keys 14 by utilizing a void file F_{V} and configuring the lock controllers 16, 18, 20, etc., to check all key codes C_{K} against the void file values, as described above. Depending on the number of users, frequency of card loss, user turnover, average expiration period, etc., the void file F_{V} of each controller 16, 18, 20, etc., may become filled and unable to store additional values without servicing the lock controller 16.

As such, each lock controller 16, 18, 20, etc., is preferably further configured to at least store, and preferably also write, void file values fv that each include both an identifier portion corresponding to the voided code identifier segment S_{I} and an expiration date portion corresponding to the expiration segment S_{E} of the particular voided key code C_{K}. Further, the lock controllers 16, 18, 20, etc. are also configured to separately remove or delete each one of the void values fv from the void file F_{V} after the expiration date of the void value f_{V}. In addition, each controller 16, 18, 20, etc. is programmed to remove/delete a void value fv from the void file F_{V} when the file F_{V} includes a predetermined maximum number (e.g., 20) of void values f_{V} and the particular void value f_{V} has an expiration date earlier than the dates of all the other void values f_{V}. Thus, by at least storing, and preferably also writing, void values f_{V} that include an expiration date, the lock controllers 16, 18, 20, etc. are each able to automatically purge void values f_{V} from the void file F_{V}, and therefore prevent the controller void file F_{V} from being filled with voided codes and unable to receive additional, more recent void values f_{V}.

Referring to FIGS. 2, 3, 8 and 10, each door lock Lₙ preferably includes an actuator 34 configured to adjust the associated lock Lₙ between the locked and unlocked states, and each controller 16, 18, 20, etc. is operatively coupled with the lock actuator 34 of the associated lock Lₙ. As such, the controller 16, 18, 20, etc. adjusts or operates the coupled lock L₁, L₂, L₃, etc. through the particular actuator 34. In certain embodiments, the locks Lₙ may include a latch 35 displaceable between an extended position and a retracted position and a handle 36 operatively connectable with the latch 35 to displace the latch between the two positions. With such locks Lₙ, the lock actuator 34 may be configured to releasably connect the handle 36 with the latch 35, such as by means of a clutch assembly (none shown). Other locks Lₙ having latches 35 may include a mechanism (none shown) for directly displacing the latch 35 between the extended and retracted positions. Further, certain locks Lₙ may include at least one electromagnet 38 configured to secure the coupled door Dₙ within a frame F when electric power is supplied to the electromagnet 38, in which case the actuator 34 is a preferably a switch 39 (e.g., a relay) controlling electric power supplied to the electromagnet 38. The scope of the present invention is not in any manner limited by the type(s) of locks Lₙ, as the access control system 10 may be used with any type of lock Lₙ capable of being operated by a controller or similar device.

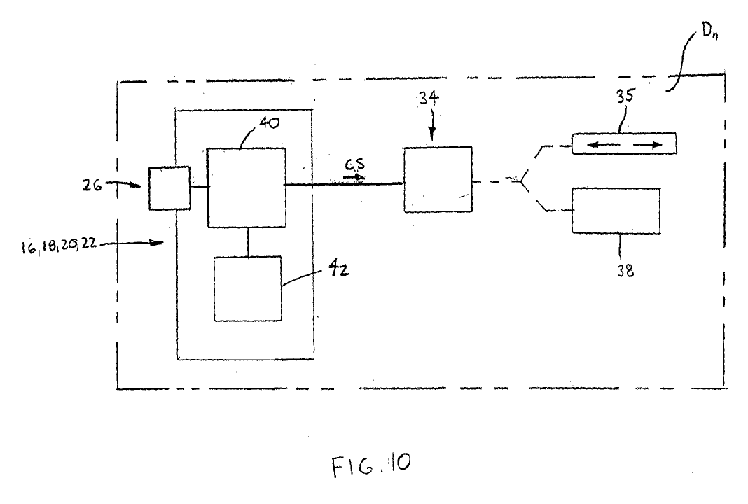

Referring to FIGS. 3 and 8-10, each controller 16, 18, 20, etc. preferably includes a microprocessor 40 and one or more memory chips 42 coupled with the microprocessor 40 and providing the controller memory 17, 19, 21, etc. The microprocessors 40 are each electrically connected with the one or more input devices 26 so as to receive the key code(s) C_{K} as electrical signals. Further, each microprocessor 40 is electrically connected with the actuator 34 of the associated lock Lₙ and is configured to generate and transmit a control signal CS (FIG. 10) to the actuator/relay when the microprocessor 40 determines that the lock Lₙ should be adjusted or operated, as discussed above. Furthermore, the memory chips 42 are each electrically coupled with the associated microprocessor 40 and have installed therein at least the controller access value V_{An}, audit file F_{A} and void file F_{V}, as discussed above. However, each controller 16, 18, 20, etc. may be of any other appropriate construction, such as for example, an analog control device, etc. Additionally, the microprocessors 40 and memory chips 42 are preferably disposed generally proximal to the associated lock Lₙ, for example within a housing 44 mounted to the door Dₙ secured by the particular lock Lₙ, as shown in FIG. 8.

Referring to FIG. 2, to illustrate certain principles of the access control system of the present invention, an exemplary access plan for the depicted office building B is outlined below. The access plan utilizes a six character access value V_{An} for each controller 16-24 in the control system 10, with three portions P_{V1n} P_{V2n}, P_{V2n} of two characters each indicating three different characteristics P_{D1}, P_{D2}, P_{D3} of each door Dₙ in the office building B, as follows. The first value portion P_{V1n}, includes two characters that indicates the door location P_{D1} as either exterior (00) or interior (01), the second value portion P_{V2n} indicates the intended user gender P_{D2} as both sexes (00), male (01), or female (11), and the third value portion P_{V3n} indicates the door security P_{D3} as low (00) and high (01). Using this value scheme, the access value for each of the five different types of doors D₁-D₅ are written as follows:

| | | | P_{V1} | P_{V2} | P_{V3} |
|---|---|---|---|---|---|
| Entrance Doors | D₁ | V_{A1} = | 00, | 00, | 00 |
| Office Doors | D₂ | V_{A2} = | 01, | 00, | 00 |
| Women's Bathroom Door | D₃ | V_{A3} = | 00, | 10, | 00 |
| Men's Bathroom Door | D₄ | V_{A4} = | 00, | 01, | 00 |
| Secured Closet Doors | D₅ | V_{A5} = | 00, | 00, | 01 |

With the above access value scheme, the following three keys 15A, 15B, 15C and 15D maybe created for four different employees, as follows:

| | | | S_{C1} | S_{C2} | S_{C3} | S_{T} | I_{SI} | R_{SI} | S_{E} |
|---|---|---|---|---|---|---|---|---|---|
| Employee One (male) | 15A | C_{K1} = | 00 | 01 | 00 | 01 | 001 | 2106 | 106 |
| Employee Two (female) | 15B | C_{K2} = | 01 | 10 | 00 | 01 | 002 | 1 | 106 |
| Employee Three (male) | 15C | C_{K3} = | 01 | 01 | 00 | 01 | 003 | 1 | 106 |
| Employee Four (female) | 15D | C_{K4} = | 01 | 10 | 01 | 00 | 004 | 1 | 108 |

Keys 15A, 15B, 15C each have a time restriction (S_{T}=01) which will causes each lock controller 16-24 to deny Employee One, Two and Three the ability to access any door Dₙ during a designated time period (e.g., between 8:00 p.m. and 6:00 a.m.), and Key 15D has no time restriction (S_{C4}=00), such that Employee Four may access authorized doors Dₙ at any time. Additionally, each key code C_{K} has an identifier segment S_{I} that includes a three digit identifier portion I_{SI} (001, 002, etc.) uniquely identifying each employee and a replacement code portion R_{SI}, which indicate the issuance of the card. In this example, keys 15B, 15C, 15D are the original issue (R_{SI}=1) and key 15A is a second issue (cᵣ=2), i.e., key 15A replaced/reissued once and indicates that the lost/stolen key will expire January 2006. Also, each key code C_{K} further has an third digit expiration date segment S_{E} that indicates month and year of expiration, the first three keys 15A, 15B, 15C expiring in January 2006 (S_{E}=106) and the fourth key 15D expiring in January 2008 (S_{E}=108).

For this example, each lock controller 16-24 is configured to compare each code segment S_{Cn} with each corresponding access value portion P_{Vn}, i.e., each code first segment S_{C1} with each value first portion P_{V1}, each code second segment S_{C2} with each value second portion P_{V2}, and each code third segment S_{C3} with each value third portion P_{V3}. Furthermore, except as discussed below, each controller 16-24 is also configured to find correspondence between a code segment S_{Cn} and the corresponding access portion P_{Vn} when the code segment value is equal to or greater than the access value portion, and to require all three code segments S_{C1}, S_{C2}, S_{C3} to correspond with the three access value portions P_{V1}, P_{V2}, P_{V3}. The exception to this basic “correspondence rule” is the controllers 20, 22 controlling access through the doors D₃, D₄ of the two bathrooms should each be programmed or otherwise configured to require an exact match between each code second or “gender” segment S_{C2}, and the access value second portion P_{V32}, P_{V42}. However, each lock controller 16-24 may be configured to compare only one or more selected code segments S_{Cn} with the controller's access value V_{An} or/and having any other desired matching criteria. For example, each lock controller 24 of the secured closet doors D₅ may have an access value V_{An} that indicates a high security characteristic P_{D3}, such that V_{A4}=01, and be programmed to compare the third code segment S_{C3} of each key 1A-15D with the controller access value V_{A4}.

With the above-described exemplary access control system 10, Employee One may present his key 15A to obtain access through any of the three entrance doors D₁ and through the Men's bathroom door D₃. However, if he presents the key 15A to the any of the office doors D₂ (office 1-3, engineering or conference room), the second lock controllers 18 will deny access due to the non-correspondence of the code first segment S_{C1} (00) with the controller value first portion P_{V21} (01) (i.e., door type not authorized). Further, if he presents the key 15A to the women's bathroom door D₃, the third controller 20 will deny access due to a non-correspondence of the code second segment S_{C2} (00) and the controller value second portion P_{V32} (10) (i-e., gender is unauthorized).

Employee Two may use her key 15B to access the three entrance doors D₁, the five interior office doors D₂, and the women's bathroom door D₃. However, key 15B would not provide her with access through the men's bathroom door D₄ and the secured closet doors D₅. Similarly, Employee Three may use his key 15C to obtain access through the three entrance doors D₁, the five interior office doors D₂, and the men's bathroom door D₄, but would be denied access through the women's bathroom door D₃ and the secured closet doors D₅.

Finally, Employee Four will be able to use key 15D to access all the doors except the men's bathroom door D₄. For example, if she presented her key 15D to one of the secured closet doors D₅, the fifth lock controller 24 will determine that the first code segment S_{C1} (01) matches the first, “location” value portion P_{V1} (00), that the code second segment S_{C2} (00) matches the second, “gender” value portion P_{V2} (00), and that the code third segment S_{C3} (01) matches the third, “security” value portion PV₃ (01), and will then adjust the lock L₅ to the unlocked state. However, if she presented the key 15D to the men's bathroom door D₄, she would be denied access through the door D₄ due to non-correspondence between the key code second segment S_{C2} (10) and the access value gender portion P_{V2} (01) of the fourth lock controller 22.

The above-described access plan/scheme is just one example of the implementation of the access control system 10 of the present invention that has been provided to illustrate certain features and the flexibility of control system 10. It must be emphasized that the access control system 10 may be used with any desired number of doors Dₙ, any number and/or types of controllers 16, 18, 20, etc., any number or appropriate type of locks Lₙ, etc. Further, the control system 10 may utilize any desired structure of the key codes C_{Kn} having any number of code segments Scn indicating any desired door characteristic P_{Dn}, using any desired symbols, characters, etc., having any desired number of different codes C_{1K}, C_{2K}, C_{3K}, etc. on each key 14, and/or carrying or generating the one or more key codes C_{K} using any appropriate type of key or credential.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined herein and by the appended claims.

I claim:

1. An access control system for at least one structure having at least first and second doors, each door having a lock adjustable between a locked state and an unlocked state, the control system comprising:
a key with a code, the code including at least a first segment and a second segment;
a first controller operatively coupled with the first door lock and having a memory with a stored value, the controller being configured to receive the code from the key, to compare at least the first value segment with the stored value, and to adjust the first door lock to the unlocked state when the controller determines that the code first segment corresponds with the first controller value; and
a second controller operatively coupled with the second door lock and having a memory with a stored value, the second controller being configured to receive the code from the key, to compare at least the code second segment with the second controller stored value, and to adjust the second door lock to the unlocked state when the second controller determines one of:
that the code second segment corresponds with the second controller value; and
that the code first segment corresponds with a first portion of the second controller value and the code second segment corresponds with a second portion of the second controller value.

2. The access control system as recited in claim 1 wherein the stored value of the first controller indicates at least one characteristic of the first door and the stored value of the second controller indicates at least one characteristic of the second door.

3. The access control system as recited in claim 2 wherein each characteristic of the first and second doors is one of location, security level, department, door type, authorized user gender, authorized user rank, and authorized user position.

4. The access control system as recited in claim 2 wherein the key code first segment corresponds with the at least one characteristic of the first door and the code second segment corresponds with the at least one characteristic of the second door.

5. The access control system as recited in claim 2 wherein:
each of the first and second doors has a first characteristic, the second door farther having a second characteristic, the first door lacking the second characteristic;
the first controller stored value indicates the first characteristic; and
the second controller stored value has a first portion indicating the first door characteristic and a second portion indicating the second door characteristic.

6. The access control system as recited in claim 5 wherein the key code first segment corresponds with the first door characteristic and the code second segment corresponds with the second door characteristic.

7. The access control system as recited in claim 6 wherein:
at least one of the first and second doors has a third characteristic and the stored value of the controller associated with the at least one door has a portion indicating the third door characteristic;
the key code farther has a third segment, the third segment corresponding with the third door characteristic; and
the controller of the at least one door being farther configured to compare the third segment with the controller stored value and to adjust the associated lock to the unlocked state when one of:
the third segment corresponds with a portion of the stored value; and
the third segment corresponds with a portion of the stored value and at least one of first and second segments corresponds with another portion of the stored value.

8. The access control system as recited in claim 1 wherein:
the key code further has an identifier segment indicating identity of an assigned user of the key; and
at least one of the first and second controllers farther includes an audit file stored within the memory and is configured to use the identifier segment to save a record of usage of the key within the audit file.

9. The access control system as recited in claim 8 wherein the at least one controller further includes a void user file stored in the memory and is configured to compare the code identifier segment with each value within the void file and to prevent lock operation when the identifier segment corresponds with a value in the void file.

10. The access control system as recited in claim 9 wherein:
the code identifier segment includes a user identity portion and a replacement code portion;
the at least one controller is configured to compare the user identity portion with each of the void file values and to write a new void value in the void file when the controller determines that one of the void values includes the identity portion and a replacement code portion with a value different than a value of the key code replacement code portion.

11. The access control system as recited in claim 1 wherein:
the key code further has a time segment indicating one of an authorized usage period and unauthorized usage period; and
each of the first and second controllers includes a clock and is configured to prevent operation of the associated lock when the controller determines from the code time segment that the key code is received during an unauthorized usage period.

12. The access control system as recited in claim 1 wherein:
the key code further has a date segment indicating one of at least one authorized usage date and at least one unauthorized usage date; and
each of the first and second controllers includes a calendar and is configured to prevent operation of the associated lock when the controller determines from the code date segment that the key code is received on an unauthorized usage date.

13. The access control system as recited in claim 1 wherein the key code is one of encoded data stored on the key, a bar code disposed on the key, and an electromagnetic data signal generated by the key.

14. The access control system as recited in claim 1 wherein one of:
the key has a storage medium, the code being stored in the medium; and
the key has an electronic switching circuit configured to generate a signal, the signal providing the code.

15. The access control system as recited in claim 14 wherein the storage medium includes one of a memory chip, a plurality of electrical switches, a magnetic stripe, a bar code, and a holographic image.

16. The access control system as recited in claim 1 wherein each one of the key code first and second segments corresponds with at least one character, the at least one character indicating a characteristic of at least one of the first and second doors.

17. The access control system as recited in claim 1 wherein the key code corresponds with a plurality of characters, the code first segment including at least one of the plurality of the characters and the code second segment including a remainder of the plurality of characters.

18. The access control system as recited in claim 1 wherein the key code corresponds with a string of characters, the first code segment including at least one character of the string and the second segment including the remainder of the character string.

19. The control system as recited in claim 1 wherein each one of the first and second controllers is configured to determine that one of the code first and second segments corresponds with the stored value of the one controller when one of:
the one code segment has a value equal to the stored value;
the one code segment has a value greater than the stored value;
the one code segment has a value lesser than the stored value;
the one code segment has a value equal to a portion of the stored value; and
a portion of the one code segment has a value equal to the stored value.

20. The access control system as recited in claim 1 wherein:
the first controller stored value has a first portion and a second portion; and
the first controller is configured to compare the code first segment with the stored value first portion, to compare the code second segment with the stored value second portion, and to adjust the first door lock to the unlocked state when the first controller determines one of:
that the code first segment corresponds with the value first portion;
that the code second segment corresponds with the value second portion; and
that the code first segment corresponds with the value first portion and the code second segment corresponds with the value second portion.

21. The access control system as recited in claim 1 wherein:
the structure includes a plurality of the first doors and a plurality of the sec and doors, each one of the first and second doors having a lock adjustable between a locked state and unlocked state; and
the access control system comprises a plurality of the first controllers, each first controller being operatively coupled with a separate one of the first door locks, and a plurality of the second controllers, each second door being operatively coupled with a separate one of the second doors.

22. The access control system as recited in claim 1 wherein:
the structure further has a third door, the third door having a lock adjustable between locked and unlocked states;
the key code further has a third segment; and
the access control system further comprises a third controller operatively coupled with the third door lock and having a memory with a stored value, the third controller being configured to receive the code from the key, to compare at least the code third segment with the stored value of the third controller, and to adjust the third door lock to the unlocked state when the third controller determines one of:
that the code third segment corresponds with the third controller value;
that one of the code first segment and the code second segment corresponds with a portion of the third controller value and the code third segment corresponds with another portion of the third controller value; and
that the code first segment corresponds with a first portion of the third controller value, the code second segment corresponds with a second portion of the third controller value, and the code third segment corresponds with a third portion of the third controller value.

23. The access control system as recited in claim 1 wherein:
the at least one structure further has a third door, the third door having a lock adjustable between a locked state and an unlocked state;
the key code is a first code and the key further has a second code;
each of the first and second controllers is configured to receive both the first and second codes and to select the first code for comparison with the controller stored value; and
the access control system further comprises a third controller operatively coupled with the third door lock and having a memory with a stored value, the third controller being configured to receive both the first and second codes from the key, to select and compare the second code with the stored value and to adjust to adjust the third door lock to the unlocked state when the third controller determines that at least a portion of the second code corresponds with at least a portion of the third controller value.

24. The access control system as recited in claim 23 wherein:
the key second code has a first segment and a second segment; and
the third controller stored value has a first portion and a second portion and the third controller is configured to adjust the third lock to the unlocked state when the third controller determines one of:
that the second code first segment corresponds with the third controller value first portion;
that the second code second segment corresponds with the third controller value second portion; and
that the second code first segment corresponds with the third controller value first portion and the second code second segment corresponds with the third controller valise second portion.

25. The access control system as recited in claim 1 further comprising a second key having a code, the second key code corresponding with the first controller stored value, each of the first and second controller being configured to receive the code from the second key such that the first controller adjusts the first door lock to the unlocked state when the first controller receives the second key code and the second lock is nonadjusted when the second controller receives the second key code.

26. The access control system as recited in claim 1 wherein:
the key value is a first code and the key further has a second code with a first segment and a second segment;
the first controller is configured to receive both of the first and second key codes, to compare the first code segments of each of the first and second key codes with the first controller stored value and to adjust the lock to the unlocked state when the first controller determines that either one of the first and second key code first segments corresponds with the first controller stored value.

27. The access control system as recited in claim 26 wherein the second controller is configured to receive both of the first and second key codes, to compare the first and second code segments of each one of the first and second key codes with the second controller stored value and to adjust the lock to the unlocked state when the first controller determines the first and second code segments of one of the first and second key code first segments corresponds with the second controller stored value.

28. The access control system as recited in claim 1 wherein each one of the first and second doors is disposed within a separate frame, each door being generally secured within the associated frame when the associated lock is in the locked state and being generally displaceable with respect to the frame when the lock is in the unlocked state.

29. The access control system as recited in claim 1 wherein each one of the first and second door locks includes an actuator configured to adjust the lock between the locked and unlocked states, the first controller is operatively coupled with the first lock actuator, and the second controller is operatively coupled with the second lock actuator.

30. The access control system as recited in claim 29 wherein:
at least one of the locks of the first and second doors includes a latch displaceable between a locked position and an unlocked position and a handle operatively connectable with the latch to displace the latch between the two positions; and
the lock actuator is configured to releasably connect the handle with the latch.

31. The access control system as recited in claim 29 wherein:
at least one of the locks of the first and second doors includes a latch displaceable between a locked position and an unlocked position; and
the lock actuator is configured to displace the latch between the two positions.

32. The access control system as recited in claim 29 wherein:
at least one of the locks of the first and second doors includes an electromagnet configured to secure the coupled door within a frame when electric power is supplied to the electromagnet; and
the actuator is a switch controlling electric power supplied to the electromagnet.

33. The access control system as recited in claim 1 further comprising:
a first input device configured to receive the code from the key and to transmit the code to the first controller;
a second input device configured to receive the code from the key and to transmit the code to the controller.

34. The access control system as recited in claim 33 wherein each one of the first and second input devices includes one of a card reader, an iButton port, wireless receiver, a bar code scanner, and an optical scanner.

35. The access control system as recited in claim 1 wherein:
the key code is stored on the key as a magnetic code and the key further includes a wireless transmitter configured to transmit the key code as an electromagnetic signal; and
each of the first and second controllers includes a wireless receiver configured to receive the electromagnetic signal and microprocessor electrically coupled with the receiver.

36. The access control system as recited in claim 1 wherein the memory of at least one of the first and second controllers is programmable such that the controller stored value is variable.

37. An access control system for use with at least two doors, each door having a lock adjustable between a locked state and an unlocks state, the control system comprising:
a key having a first code and a second code;
a first controller operatively coupled with the lock of a first one of the two doors and having a memory with a stored value, the controller being configured to receive the first and second codes from the key, to select one of first and second codes, to compare the selected code with the stored value, and to adjust the first door lock to the unlocked state when the controller determines that the selected code corresponds with the first controller stored value; and
a second controller operatively coupled with the lock of a second door and having a memory with a stored value, the second controller being configured to receive the first and second codes from the key, to select one of first and second codes, to compare the selected code with the second controller stored value, and to adjust the second door lock to the unlocked state when the second controller determines that the selected code corresponds with the second controller stored value.

38. An access control system for at least one structure having at least one door, the door having a lock adjustable between a locked state and an unlocked state, the control system comprising:
at least one key having a code, the code including at least one access segment, an identifier segment, and an expiration date segment; and
a controller operatively coupled with the door lock and having a memory with a stored access value and a void file, the void file being configured to store at least one void value with an identifier portion and an expiration date portion, the controller being configured to receive the code from the key, to compare the key access segment with the stored access value and the identifier segment with the identifier portion of each void file value, the controller being further configured to separately remove each one of the void values from the void file at least one of:
on or after the expiration date of the void value; and
when the void file includes a predetermined maximum number of void values and the one void value has an expiration date earlier than the expiration date of each one of the other void values.

39. The access control system as recited in claim 38 wherein:
the key code identifier segment includes a user identity portion and a replacement code portion;
the controller memory farther includes an audit file;
the controller is configured to write a value into the audit file when the controller receives a key code which corresponds to the key value, the audit value including at least a value segment corresponding to the key code identifier value segment; and
the controller is further configured to compare the user identity portion with each of the audit file records and to copy the identifier segment into the void file when the controller determines that one of the audit records includes the identity portion and a replacement code portion with a value different than a value of the identifier segment replacement code portion.

40. The access control system as recited in claim 38 wherein the controller is configured to receive at least one void code from an input device and to write the void code into the void file.

41. The access control system as recited in claim 38 wherein the controller is configured to adjust the lock to the unlocked state when the key code access segment corresponds with the stored access value and the code identifier segment corresponds with none of the void value identifier portions.

42. The access control system as recited in claim 38 wherein:
the key code includes a first access segment and a second access segment;
the controller is a first controller and is configured to compare the code first access segment with the stored value; and
access control system further comprises a second controller operatively coupled with the door lock and having a memory with a stored access value and a void file, the void file having at least one void value with an identifier portion and an expiration date portion, the second controller being configured to receive the code from the key, to compare at least the key second access segment with the second controller stored access value and the code identifier segment with the identifier portion of each void file value, the second controller being further configured to separately remove each one of the void values from the second controller void file at least one of:
on or after the expiration date of the void value; and
when the void file includes a predetermined maximum number of void codes and the one void value has an expiration date earlier than the expiration date of each one of the other void values.

43. The access control system as recited in claim 42 wherein:
the first controller is configured to adjust the lock to the unlocked state when the key code first access segment corresponds with the first controller access value and the code identifier segment corresponds with none of the void value identifier portions; and
the second controller is configured to adjust the lock to the unlocked state when one of:
the key code second access segment corresponds with the stored access value and the code identifier segment corresponds with none of the second void file value identifier portions; and
the key code first access segment corresponds with a first portion of the second controller stored access value, the key code second access segment corresponds with a second portion of the second stored access value, and the code identifier segment corresponds with none of the second void file value identifier portions.
